(19) United States
(12) Patent Application Publication
(10) Pub. No.: US 2026/0327443 A1
(43) Pub. Date: Oct. 22, 2026

(54) METAL-BASED INK COMPOSITIONS AND METHODS THEREOF

(71) Applicant: University of Maryland, College Park, College Park, MD (US)

(72) Inventors: Shenqiang Ren, College Park, MD (US); Jun Zhang, College Park, MD (US)

(21) Appl. No.: 19/649,738

(22) Filed: Apr. 16, 2026

Related U.S. Application Data
(60) Provisional application No. 63/791,400, filed on Apr. 19, 2025.

(51) Int. Cl. C09D 11/037; C09D 11/52

(52) U.S. Cl. CPC C09D 11/037; C09D 11/52

(57) ABSTRACT

This present disclosure is directed to a method for using additive manufacturing to create gold and alumina materials that are highly resistant to oxidation and corrosion in extreme environments.

### CROSS REFERENCE TO RELATED APPLICATIONS

This application claims priority to U.S. Application No. 63/791,400, filed on Apr. 19, 2025, the contents of which are hereby incorporated by reference in its entirety.

### STATEMENT OF FEDERALLY SPONSORED RESEARCH AND DEVELOPMENT

This invention was made with government support under W911NF-19-2-0011, and W911NF-25-2-0056 awarded by the Army Research Laboratory-Army Research Office. The government has certain rights in the invention.

### FIELD OF THE INVENTION

The field of the invention relates generally to a method for using additive manufacturing to create gold and alumina materials that are highly resistant to oxidation and corrosion in extreme environments.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Extreme environments demand exceptional stability and reliability of advanced materials, such as in aerospace, nuclear energy, and chemical reactors, which respectively involve rapid temperature fluctuations, prolonged high-temperature exposure (>1000 °C), and highly acidic or alkaline conditions (pH<2 or >11). These extreme conditions present significant challenges for functional materials, requiring them to maintain structural integrity, resist degradation, and ensure consistent performance in extreme environments. Particularly in high-temperature and chemically aggressive settings, maintaining oxidation resistance and preventing material failure are critical challenges. A significant obstacle to the development of harsh condition materials is the lack of inherent resistance to oxidation and corrosion, particularly in high-temperature applications within the temperature range of 600 to 1000 °C. Considerable effort has been dedicated in recent decades to enhance the durability and stability of materials utilizing materials design or the use of novel chemistry.

Metal-organic decomposition (MOD) inks stand out as a noteworthy and intriguing type of material, which serve as alternatives to metallic and ceramic nanoparticles, and involves the use of metal-organic decomposition precursor solutions explicitly synthesized for additive manufacturing. The need for additive manufacturing for harsh conditions is highly motivated by its exceptional throughput and customizability features. The precursor composition comprises metals in their ionic form, that are dissolved within solvents or organic complexing agents that function as solvents. Being virtually devoid of dispersed particles, the complex electronic circuits could be additively manufactured by using the MOD ink materials, for the formation of an aggregated percolation network of metallic or ceramic traces.

Therefore, there is a need to develop materials that can be used in extreme conditions like aerospace and energy applications that have intrinsic resistance to oxidation and corrosion, particularly in high temperature environments.

### SUMMARY

Herein, a one-step conversion coupled with additive manufacturing of extreme environment capable metal-ceramic materials by using printable MOD molecular strategy is introduced. The resulted materials exhibit a remarkable combination of thermal resilience and corrosion resistance, making them highly suitable for hash conditions. This approach was exemplified for the case of oxidation- and corrosion-resistant gold (Au) and alumina (Al₂O₃). The MOD-decomposed Au traces exhibit high conductivity, while the alumina ceramics produced by MOD inks are uniform and dense, offering exceptional chemical and wear resistance, and excellent mechanical and thermal stability, making them promising for harsh environment electronics. Specifically, the Au materials exhibit extremely low sheet resistance and very high conductivity at extreme temperatures.

In-situ wide-angle X-ray scattering (WAXS) spectra reveal the crystal structure and temperature-dependent behavior to provide a mechanistic understanding of its structural transformation. In addition, it shows corrosion resistance when immersed in acidic and basic solutions, namely HCl and NaOH with molarities of 0.1, 1, and 5 M, respectively. Given that the oxidation kinetics are influenced by the rate at which oxygen diffuses across the surface of the conductor, the Au exhibits steady electrical performance after 37 hours of aging at 1100 °C. Due to the excellent chemical and temperature stability of Au and temperature-sensitive dielectric properties of Al₂O₃, the Au was integrated with the Al₂O₃ to present a printed Resistance-Temperature Detector (RTD) that exhibits consistent performance over a temperature range from 600 to 1000 °C with a sensitivity of 8.2×10⁻⁵Ω/°C at 1000 °C. The printed dipole antenna exhibits a resonance frequency shift at higher temperatures attributed to the dielectric constant change of Al₂O₃, enabling a battery-free telemetric reading option for remote sensing applications.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1 Fabrication process of printed electronic devices. (a) Molecular structure of gold (Au)-MOD and aluminum (Al)-MOD ink, and printing them onto a substrate, where the ink is processed through heat to form a nanoparticle structure. (b) In-situ WAXS patterns of the Au inkling using NaBH₄ as reducing agents at various temperatures from 20 to 1000 °C. The 2D WAXS patterns at 500 and 1000 °C are shown above for reference. (c) Microscopy images of the printed Al₂O₃ film (left) and Au particle film (right), with a zoomed-in view of the Au particle film. (d) Heat resistance of Au films at 1100 °C (e) Printable patterns applied in electronic devices.

FIG. 2 Characterization of sintered Au films. (a) Comparison of sheet resistance for Au films using different reducing agents. (b) Effect of Au concentration on sheet resistance, with SEM images. (c) SEM image of Au film. (d) Cross-sectional SEM image of Au film (thickness ~4.5 μm) with Au elemental mapping inset. (e) XRD patterns of Au films sintered at 180 and 1000 °C (f) Sheet resistance (R) and conductivity (6) vs. sintering temperature.

FIG. 3 Stability and electrochemical performance of Au films in different acidic and basic environments. (a) Resistance (R) vs. time (t) for Au films in 0.1 M HCl and 0.1 M NaOH solutions. (b&c) Long-term stability test of Au films in 1 M and 5 M HCl and NaOH, with inset images showing multimeter readings. (d) SEM images of Au films after immersion in 5 M HCl (top) and 5 M NaOH (bottom). (e) Schematic of the electrochemical cell setup (left), and cyclic voltammetry curves for Au films in 0.1 M NaOH (center) and 0.02 M HCl (right).

FIG. 4 Thermal and structural characterization of Al₂O₃ and Au films. (a) TGA curve of Al-MOD ink, showing weight loss as a function of temperature, with SEM images of the Al film sintered at 1000 and 200 °C (b) XRD patterns of Al₂O₃ films sintered at various temperatures and durations, with peaks corresponding to γ-Al₂O₃ and α-Al₂O₃ phases. (c) SEM images of Au film (top) and Al₂O₃ film (bottom) after sintering. (d) Dielectric constant vs. frequency for Al₂O₃ films sintered at different temperatures, indicating the temperature dependence of the dielectric properties.

FIG. 5 Stability analysis of Au films sintered at different temperatures. (a) Resistance (R) vs. time (t) of Au films for resistance temperature test at 1000 and 1100 °C (b) XRD patterns of Au films sintered at 1000 and 1100 °C, along with cycling from 20 to 1000 °C, indexed to Au (JCPDS file: 04-0784). (c) SEM images and (d) optical images showing the nanoscale morphology of Au films before and after the resistance temperature test at 1000 °C (e) In-situ WAXS patterns of Au nanoparticles ink from RT to 1000 °C (f) 2D WAXS pattern of Au nanoparticles ink sintered at 500 and 1000 °C.

FIG. 6 Resistance and frequency response of a high-temperature sensor. (a) Resistance curves over multiple cycles (Run 1 to Run 5) showing the thermal behavior of Au films during heating and cooling from 20 to 1000 °C (b) Peak resistance (R) at different temperatures from 600 to 1000 °C (c) Temperature (T) vs. resistance (R) plots from multiple cycles with a polynomial fit of the concatenated data. (d) Optical image illustrating the system comprising data collecting and wireless transmission component for the printed RTD sensor. (e) Si parameter as a function of frequency, showing the frequency response of Au films sintered at different temperatures from RT to 600 and 1000 °C (f) Su parameter as a function of frequency, showing the frequency response of Au films coated with Al₂O₃ film sintered at different temperatures from RT to 600 and 1000 °C.

FIG. 7 Resistivity variation with temperature of Au film in torch test.

FIG. 8 In-situ WAXS patterns of Au ink prepared with different reducing agents. (a) ascorbic acid, (b) citric acid, (c) dopamine. (d) The 2D WAXS patterns of Au ink using ascorbic acid at 300, 700, and 1000 °C. It shows the evolution of crystallographic planes (111), (200), (220), (311), and (222) at elevated temperatures.

FIG. 9 UV-Vis absorption spectra of Au ink with different reducing agents. The spectra display distinct absorption features for Au ink using NaBH₄, ascorbic acid, dopamine, and citric acid, with peak absorbance observed at different wavelengths, indicating variations in particle size and distribution.

FIG. 10 SEM images of gold nanoparticles (Au NPs) synthesized using different reducing agent. The images illustrate the variation in particle morphology and aggregation patterns depending on the reducing agent used.

FIG. 11 SEM images showing the morphology of nanoparticles sintered at 200 °C. From left to right, top to bottom: (a) 0.25 mg/μl, (b) 0.5 mg/μl, (c) 1.0 mg/μl, (d) 2.0 mg/μl, (e) 4.0 mg/μl, and (f) 20.0 mg/μl. The images illustrate the changes in particle aggregation and structure as the concentration increases.

FIG. 12 SEM images showing the morphology of nanoparticles sintered at 1000 °C. From left to right, top to bottom: (a) 0.25 mg/μl, (b) 0.5 mg/μl, (c) 1.0 mg/μl, (d) 2.0 mg/μl, (e) 4.0 mg/μl, and (f) 20.0 mg/μl. The images illustrate the changes in particle aggregation and structure as the concentration increases.

FIG. 13 SEM-EDX mapping images showing the elemental distribution of Cu contamination. (a) SEM image highlighting the Cu contamination region. (b) Oxygen (O) elemental map. (c) Copper (Cu) elemental map. (e) Gold (Au) elemental map. The images show the spatial distribution of oxygen, copper, and gold across the sample, with the contamination region visible.

FIG. 14 Cyclic voltammograms of Au film in 0.1 M KCl solution. It shows the redox behavior of the Au. The multiple cycles (50) indicate the stability and electrochemical performance of the Au film under repeated potential scanning.

FIG. 15 Characterization of the Al formate synthesized via the hydrothermal method. (a) SEM image showing the morphology of the hydrothermally synthesized Al formate. (b) XRD pattern of the synthesized aluminum formate hydrate, with the peaks indexed to JCPDS No. 38-0655. The inset shows a photograph of the powder sample.

FIG. 16 SEM images and XRD patterns of the mixture of aluminum formate and glycerol sintered at different temperatures. (a) SEM images showing the morphology of the samples sintered at 800 °C and 1100 °C (b) XRD patterns of the samples, indicating the formation of γ-Al₂O₃(JCPDS No. 29-0063) and α-Al₂O₃ (JCPDS No. 10-0173) at different sintering temperatures. The peaks suggest phase transitions as the temperature increases.

FIG. 17 FTIR spectra of aluminum-based compounds at various stages of thermal treatment. Spectra are shown for Al(OH)₃, Al formate, and Al formate sintered at 200 °C for 5 min, 600 °C for 5 min, and 1000 °C for 60 min. The spectra display the evolution of vibrational modes as a function of temperature, indicating structural changes in the material during the thermal decomposition process.

FIG. 18 SEM images of films after sintering at 1000 °C.

FIG. 19 SEM images comparing the morphology of Au ink contaminated by aluminum formate, Al(HCOO)₃ (left), and aluminum hydroxide, Al(OH)₃ (right). Both samples exhibit differences in particle size and distribution, with the aluminum oxide and Au expected to phase separately.

FIG. 20 TEM images of Au nanoparticle ink.

Particular non-limiting embodiments of the present invention will now be described with reference to accompanying drawings.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

As used herein, the term “noble metal” refers to a group of metallic elements known for their resistance to corrosion and oxidation.

The term “metallic MOD ink composition” is used interchangeably with the term “MOD ink composition” to refer to a metal-organic decomposition (MOD) ink

The term “molecular ink” as used herein refers to a conductive ink used for printed electronics, composed of ionic or metal-organic precursors that undergo thermal decomposition to form a continuous metallic network. Unlike nanoparticle-based inks, molecular inks provide enhanced stability, reduced oxidation risks, and tunable sintering temperatures, making them suitable for flexible and printed electronic applications.

The term “conductive ink” as used herein refers to printable materials containing conductive molecules.

The term “MOD ink” as used herein refers to a metal-organic decomposition ink.

As used herein the term “high redox metal-based ink composition” refers to an ink comprising a metal salt (and optionally formic acid) with a redox potential greater than about 1.5. Such metal salts include Al (III), Zr (III), Ti (III), W(III), Cr (III), Group IV-VI metals, etc. In some embodiments, said composition is a MOD ink composition. In other embodiments, said composition is a conductive ink.

As used herein the term “noble metal metal-based ink composition” refers to a composition comprising a metal salt and a reducing agent (such as sodium borohydride, dopamine, citric acid, or formic acid), and optionally a solvent such as water. In some embodiments, said reducing agent is a mild reducing agent. In some embodiments, said composition is a MOD ink composition. In other embodiments, said composition is a conductive ink. In some embodiments, said metal salt may be gold, silver, palladium, or platinum.

As used therein, the term “organic solvent” refers to a solvent that contain carbon and oxygen in their composition. Examples of organic solvents include alcohols, esters, ethers, ethyl acetate, ethanol, acetone, benzene, and ketones.

### LIST OF EMBODIMENTS

The following is a non-limiting list of embodiments:
1. A noble metal-based ink composition, said composition comprising a metal salt and a reducing agent (such as sodium borohydride), and optionally an organic solvent or water.
2. The noble metal-based ink composition of embodiment 1, water wherein said ink composition is a conductive ink composition.
3. The noble metal-based ink composition of the preceding embodiments, wherein said ink composition is a metallic MOD ink composition.
4. The noble metal-based ink composition of the preceding embodiments, wherein said metal has a reduction potential of at least 1.2.
5. The noble metal-based ink composition of the preceding embodiments, wherein said metal has a reduction potential of about 1.2 to about 4.5.
6. The noble metal-based ink composition of the preceding embodiments, wherein said metal salt is gold, silver, palladium, or platinum. In some embodiments, said metal salt is gold.
7 The noble metal-based ink composition of the preceding embodiments, wherein said salt is a halide, carboxylate, nitrates, or sulfates.
8. The noble metal-based ink composition of embodiment 1, wherein said metal salt is present in a concentration of about 1 mmol to about 10 mmol, preferably about 2.5 mmol.
9. The noble metal-based ink composition of embodiment 1, wherein said sodium borohydride is present in a concentration of about 0.01 mmol to about 0.2 mmol, preferably about 0.05 mmol.
10. A noble metal-based ink composition, said composition comprising a metal salt, a reducing agent (such as dopamine), an acid (such as organic acid, e.g., citric acid, formic acid and/or ascorbic acid) and a solvent (such as a polar e.g., water or organic solvents).
11. The noble metal-based ink composition of embodiment 10, wherein said ink composition is a MOD ink composition.
12. The noble metal-based ink composition of embodiment 10 or 11, wherein said ink composition is a conductive ink composition.
13. The noble metal-based ink composition of any of embodiment 10-12, wherein said metal has a reduction potential of less than 1.2.
14. The noble metal-based ink composition of embodiment 13, wherein said metal has a reduction potential of about 0 to about 1.2.
15. The noble metal-based ink composition of any of embodiments 10-14, wherein said metal is gold, silver, palladium, or platinum.
16. The noble metal-based ink composition of any of embodiments 10-15, wherein said salt is a halide, carboxylate, nitrates, or sulfates.
17. The noble metal-based ink composition of any of embodiments 10-16, wherein said dopamine is present in a concentration of about 0.005 mmol to about 0.1 mmol, preferably about 0.02 mmol.
18. The noble metal-based ink composition of any of embodiments 10-17, wherein said citric acid is present in a concentration of about 0.005 mmol to about 0.1 mmol, preferably about 0.02 mmol.
19. The noble metal-based ink composition of embodiment 10, wherein said ascorbic acid is present in an amount of about 0.005 mmol to about 0.1 mmol, preferably about 0.02 mmol.
20. A high redox metal-based ink composition, said composition comprising a metal salt (such as metal hydroxide, e.g., Al(OH)₃, metal halide, metal carboxylate, nitrate, sulfate, etc.) and optionally, formic acid.
21. The high redox metal-based ink composition of embodiment 20, wherein said ink composition further comprises an amino solvent (such as 2-amino-2-methyl-1-propanol (AMP)).
22. The high redox metal-based ink composition of any of embodiments 20-21, wherein said ink composition is a MOD ink composition.
23. The high redox metal-based ink composition of any of embodiments 20-22, wherein said metal cation is a Group IV-VI metal.
24. The high redox metal-based ink composition of any of embodiments 20-23, wherein said metal cation has a reduction potential of more than 1.2.
25. The high redox metal-based ink composition of any of embodiments 20-24, wherein said metal cation has a reduction potential of about 1.2 to about 4.5.
26. The high redox metal-based ink composition of any of embodiments 20-25, wherein said metal cation is aluminum (III), chromium (III), zirconium (III), titanium (III), tungsten (III). In some embodiments, said metal salt is chosen from aluminum formate, chromium formate, zirconium formate, titanium formate, tungsten formate, hafnium-formate.
27. The high redox metal-based ink composition of any of embodiments 20-26, wherein said metal oxide is present in a concentration of about 1 mmol to about 10 mmol, preferably 2.5 mmol.
28. The high redox metal-based ink composition of any of embodiments 20-27, wherein said formic acid is present in the amount of about 0.005 mmol to about 0.1 mmol, preferably 0.02 mmol.
29. The high redox metal-based ink composition of any of embodiments 20-28, wherein said AMP is present in the amount of about 10 wt % to about 40 wt %, preferably about 20 wt %.
30. A material, said material comprising a noble metal-based ink composition of any of the preceding embodiments and/or a high redox metal-based ink composition of any of the preceding embodiments, disposed on a surface of said material.
31. The material of embodiment 30, wherein said noble metal-based ink composition is disposed on the surface of a substrate, and said high redox metal-based ink composition (e.g. an ink comprising aluminum formate) is disposed on the surface of said noble metal-based ink. In some embodiments, said noble metal-based ink composition and said metal-based ink composition are present as a composite with noble metal particles (such as gold particles) and metal oxide film (such as aluminum oxide (Al₂O₃)
32. The material of embodiment 30, wherein said noble metal-based ink and said high redox metal based ink composition are in the form of a composite material disposed on a substrate.
33. The material of any of the preceding embodiments, wherein said substrate is a ceramic from oxides or non-oxides.
34. A material comprising noble metal layer disposed on a surface of a substrate to provide a noble metal layer surface, and a metal oxide ceramic (e.g. aluminate coating) disposed on noble metal layer surface (e.g., gold coating). In some embodiments, said noble metal and ceramic are present as a composite with noble metal particles (such as gold particles) and metal oxide film or coating (such as aluminum oxide (Al₂O₃). In some embodiments, said metal oxide is present in the amorphous or crystalline phase. In some embodiments, said metal oxide (e.g., aluminate) is present in the alpha- or gamma-phase. In some embodiments, said aluminate is present in a gamma-phase.
35. A method of preparing a coated material, said method comprising
(a) providing a substrate (e.g., plastic, metal, paper, electronic component, etc.),
(b) depositing a noble metal-based ink of any of the preceding embodiments,
(c) depositing a metal-oxide based ink of any of the preceding embodiments,
(d) applying heat to sinter (e.g., at 250 °C to about 1000 °C).

In some embodiments, heat is applied after step (b) and after step (c). In other embodiment, steps (b) and (c) occur simultaneously.
36. An electronic component, said component comprising a material of any of the preceding embodiments.
37. The electronic component of embodiment 36, wherein said electronic component is a touch screen, smart packaging, flexible display, medical device, sensors, RFID, etc.
38. A method for additive manufacturing of an electronic material suitable for extreme environments, said method comprising
providing a substrate (e.g., plastic, metal, paper, electronic component, etc.),
depositing a noble metal-based ink of any of the preceding embodiments,
depositing a metal-oxide based ink of any of the preceding embodiments,
applying heat to sinter (e.g., at 250 °C to about 1000 °C).

### EXAMPLES

The following examples are provided solely to illustrate the present invention and are not intended to limit the scope of the invention, described herein.

### Example 1. Experimental Protocol-Chemicals

Gold (III) chloride trihydrate (HAuCl₄·3H₂O, ≥99.9%), Sodium borohydride (NaBH₄), 2-amino-2-methyl-1-propanol (AMP, 95%, Alfa Aesar), aluminum hydroxide (Al(OH)₃), formic acid (FA, ≥96%), dopamine hydrochloride (DA, Sigma-Aldrich), citric acid (CA, ≥99.5%, Sigma-Aldrich), and ascorbic acid (AA, Sigma-Aldrich). All reagents are commercially available and used without further purification.

### Example 2. Experimental Protocol-Synthesis Method

Au ink preparation: HAuCl₄·3H₂O (2.5 mmol) was dissolved in 1 ml of water and then was mixed with 0.05 mmol of NaBH₄, resulting in a homogeneous Au ink solution. Similarly, HAuCl₄·3H₂O (0.5 mmol) in 1 ml water were separately mixed with 0.02 mmol of dopamine, citric acid, and ascorbic acid, respectively, to obtain homogeneous Au ink solutions. The Au ink was pre-sintered on a hot plate at 150 °C, followed by sintering at 1000 °C to obtain the corresponding Au film.

Au nanoparticle ink was prepared by combining oleic acid (2 mL), oleylamine (2 mL), 1,2-hexadecanediol (2.58 g), and 16 mL of ODE in a 50 mL three-neck flask. The mixture was stirred under a nitrogen atmosphere at 120 °C for 20 minutes. Au precursor complexes were added. The reaction was then maintained at 120 °C for 10 minutes.

Aluminum ink preparation: hydrothermal synthesis was used to obtain Al(HCOO)₃. Aluminum hydroxide (1.5 g) and formic acid (150 ml) were combined in a 500 ml Teflon-lined Parr stainless steel autoclave and heated at 130 °C for 3 days. Afterward, the mixture was slowly cooled to room temperature, resulting in colorless cubic crystals of aluminum formate. The obtained crystals were thoroughly washed with ethanol and separated by vacuum filtration. The air-dried sample was further heated at 180 °C for 24 hours under ambient conditions to yield guest-free Al(HCOO)₃. Then, 20 wt % of AMP was added to the Al(HCOO)₃ powder to obtain the aluminum-based ink. This ink was printed onto a substrate and sintered at different temperatures to obtain aluminum oxide with various crystalline phases.

### Example 3. Characterization Methods

FTIR spectra were tested on a Nicolet iS5 FTIR-Spektrometer (Thermo Scientific) with the attenuated total reflection accessory. The electrical stability was assessed using a Keithley 2450 Sourcemeter alongside a box furnace for heating, employing platinum wires as electrodes and a temperature ramping rate of 5 °C/min. A thermogravimetric analyzer was performed on a TGA-50 (SHIMADZU). UV-vis absorption spectra were performed on a CARY5000 spectrophotometer. The scanning electron microscope images were acquired using the TM4000Plus Tabletop Microscope. The XRD patterns were obtained using the EQUINOX 100 X-ray Diffractometer. The electrochemical tests were performed using the Squidstat Plus (Admiral Instruments). The dielectric constant was measured using the precision impedance analyzer (Agilent 4294A). The Su parameter was measured using a Vector Network Analyzer (Pico). An in-situ WAXS experiment with an extended q-range was performed at the P08 beamline at DESY, using a beam energy of 25 keV. In the experiment, the nanoparticle samples were deposited on Sapphire (0001) single-crystal substrates. The WAXS patterns were measured at an incident angle of 1° relative to the substrate surface, using an XRD1621 flat panel detector (Perkin Elmer) positioned 700 mm away from the sample. The 2D WAXS patterns were azimuthally averaged using the PyFAI library. Heating was performed using an Anton Paar DHS 1100 with a graphite sample dome in the air. The temperature increased at a rate of 20 °C/min.

### Example 4. Results and Discussion

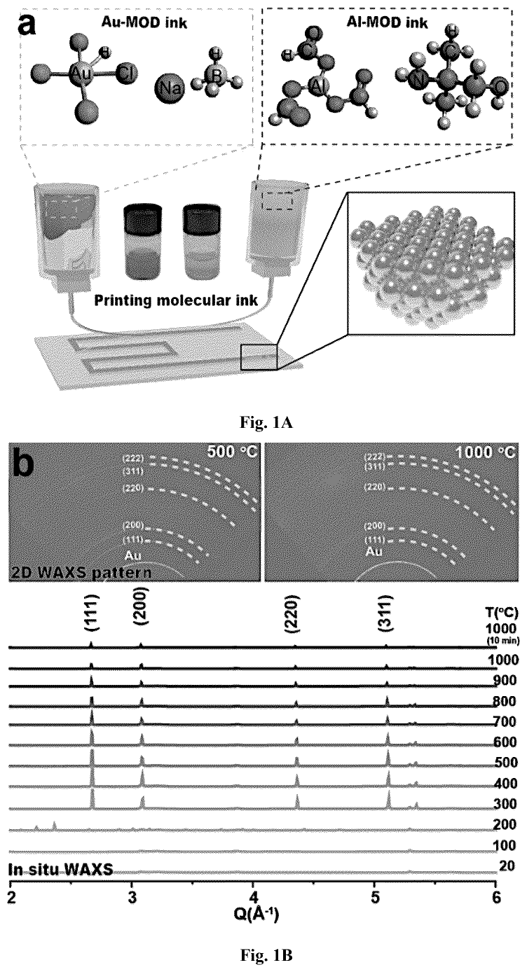

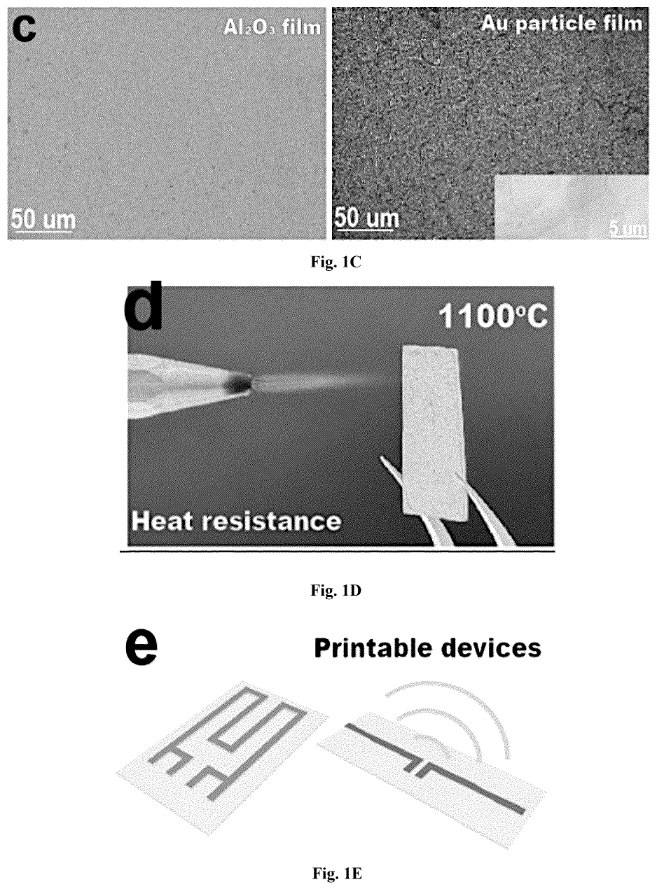

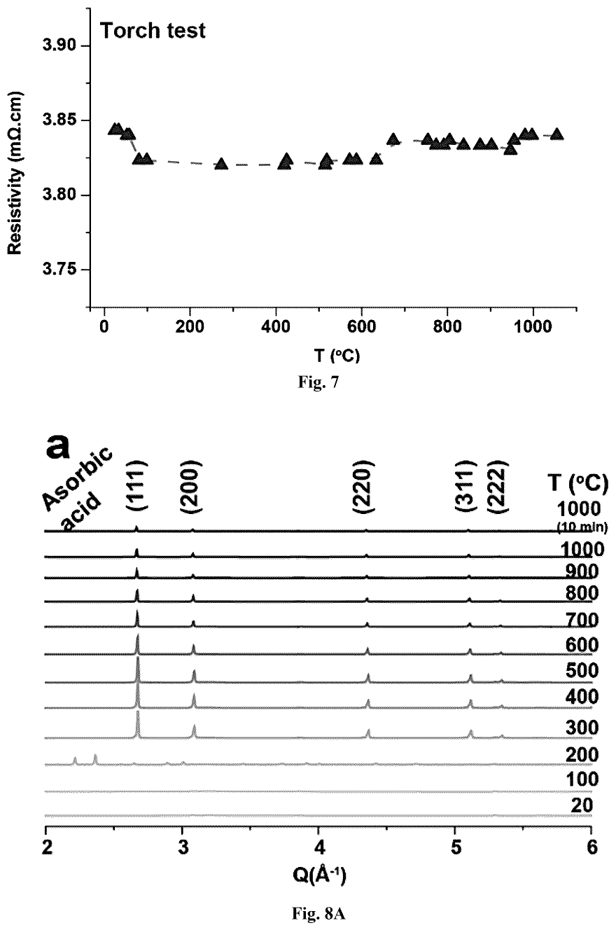

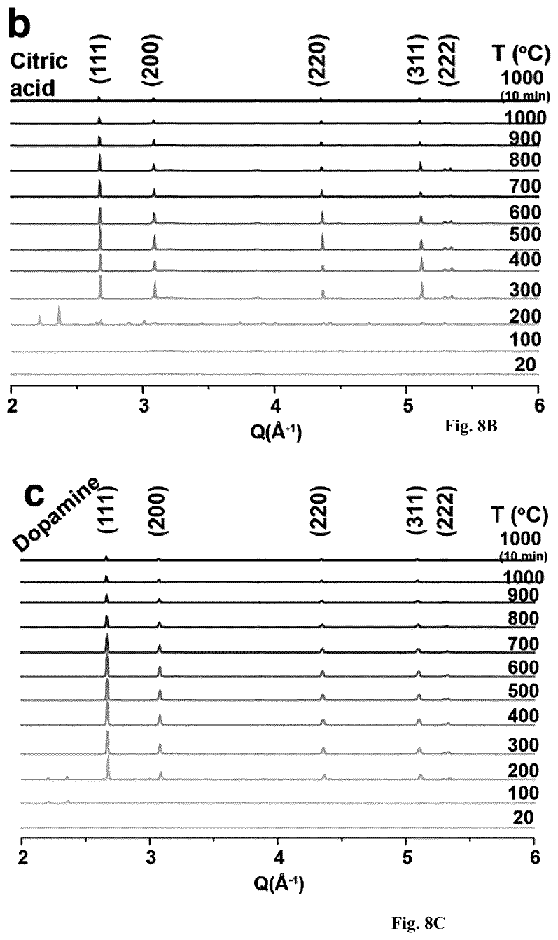

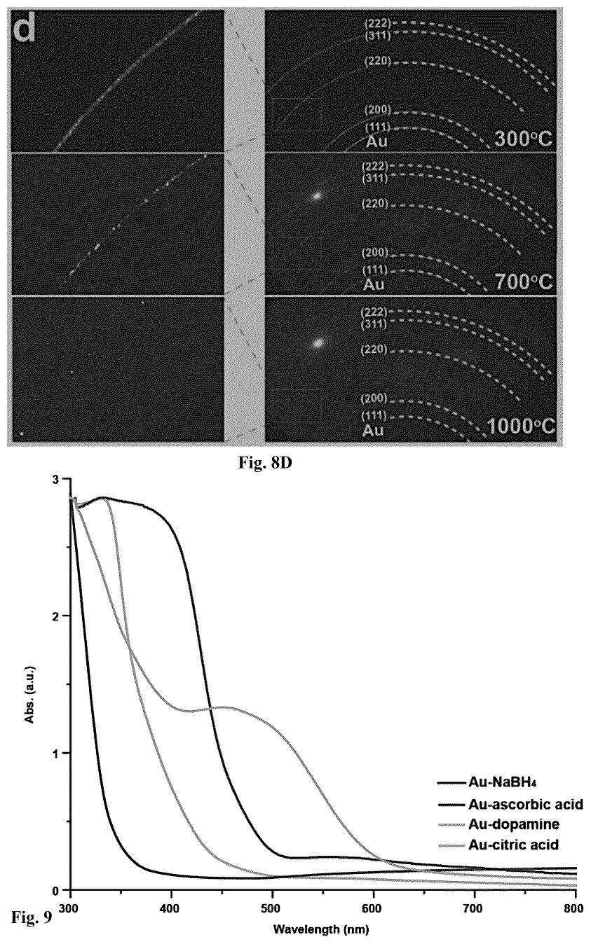

The hybrid additive manufacturing of extreme environment printed electronics using Au- and Al-MOD inks was demonstrated (FIG. 1a). The detailed preparation of the Au- and Al-MOD inks is described in the Supplementary Materials. The printing of both MOD inks with a precise, pre-designed pattern ensures uniform coverage and facilitates the creation of intricate designs suitable for electronic components (FIG. 1a). Following the printing step, the deposited ink was subjected to a sintering process at elevated temperatures. In-situ WAXS measurements were performed using synchrotron radiation to monitor the evolution of Au ink at elevated temperatures from room temperature (RT) to 1000 °C (FIG. 1b). The results showed that Au diffraction peaks, such as (111), (200), (220), and (311), were observed at 200 °C (FIG. 1b), which is related to the solvent evaporation and Au reduction process. At 300 °C, the substrate signal is significantly weakened (FIG. 1b), indicating that the impurities in the Au ink had decomposed. As the temperature is further increased (above 700 °C), the Au signal weakened (FIG. 1b), likely due to thermal expansion causing a change in sample height, which affected the signal intensity. The 2D pattern at 1000 °C became spottier compared to that at 500 °C (FIG. 1b), possibly indicating the growth of larger crystallites. The sintering process is critical for the formation of conductive and dielectric pathways, as it promotes the decomposition of metal-organic complexes and the formation of dense percolation traces. The resulting conductive Au and dielectric Al₂O₃ films after sintering are shown in FIG. 1c. The Au film is continuous and uniform, indicative of effective sintering and strong particle connectivity, which is important for high conductivity. In contrast, the Al₂O₃ film displays a rougher texture, characteristic of oxide materials. Both films preserved the integrity of the printed patterns, confirming the successful fabrication of functional films via the sintering process. The Au film can withstand 1000 °C (FIG. 1d), demonstrating excellent stability. The resistivity of the Au film shows a relatively stable trend with temperature from RT to 1000 °C during the torch test (FIG. 7), with minimal overall fluctuations, indicating that the film material maintains good conductivity at high temperatures. Combining Al₂O₃ with the Au film in a top-down structure has shown feasibility for high-temperature electronic applications (FIG. 1e).

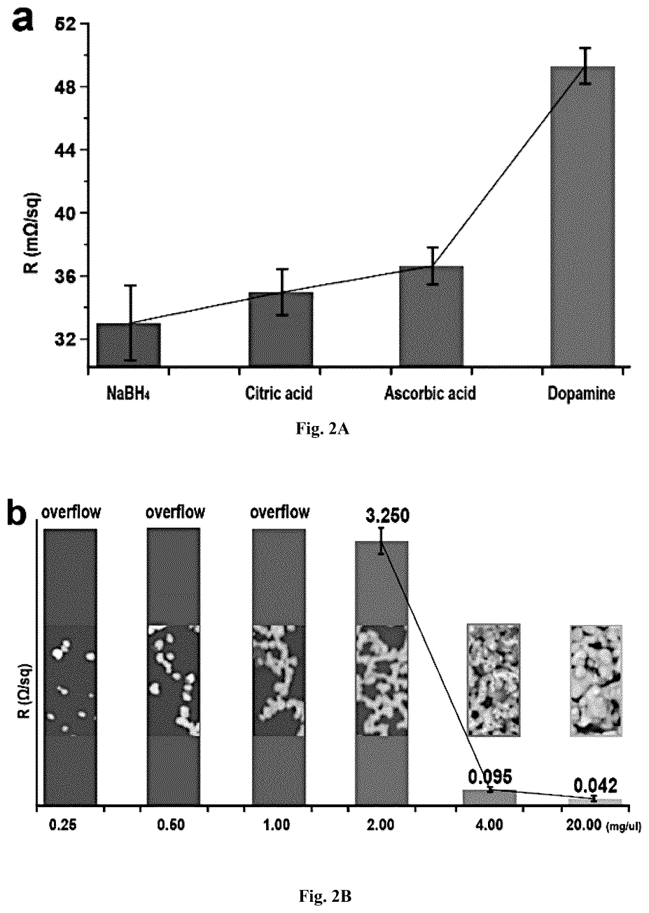

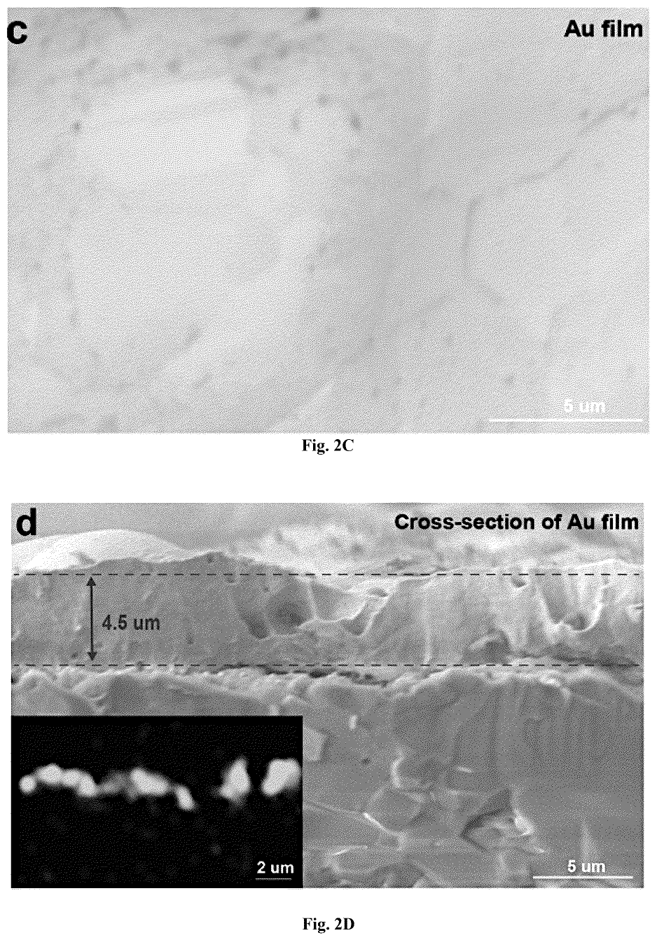

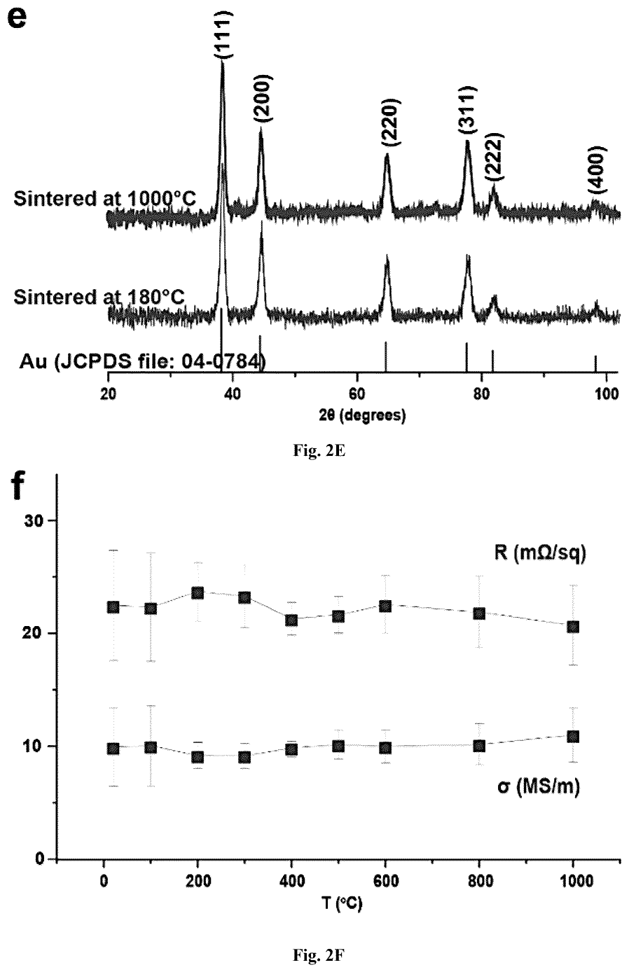

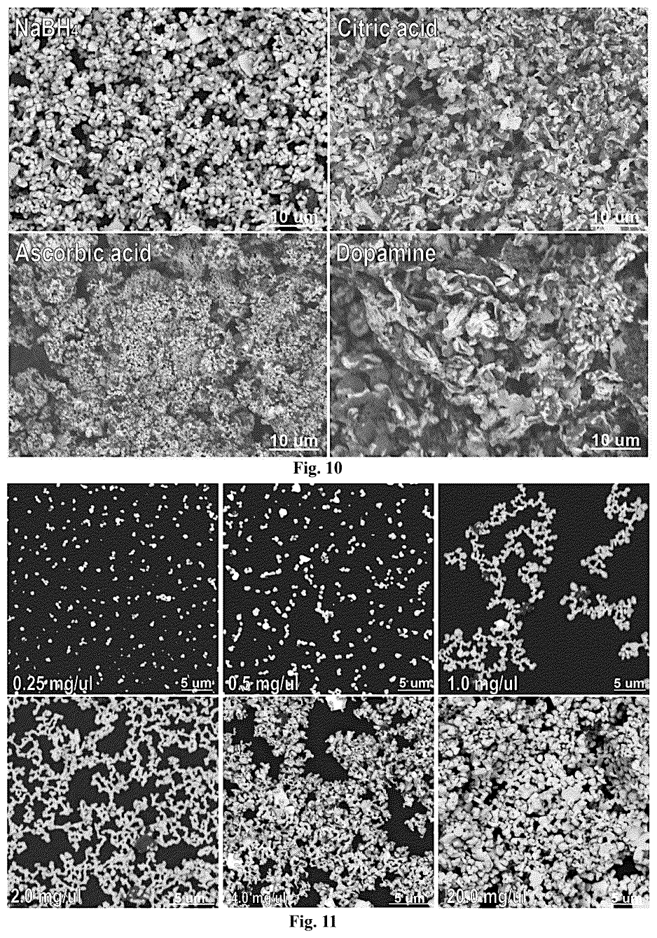

The printable Au-MOD ink materials are prepared with different reducing agents, such as NaBH₄, ascorbic acid, citric acid, and dopamine (FIG. 2a). From in-situ WAXS spectra, these inks exhibited similar crystallization behavior as the temperature increasing from RT to 1000 °C the Au diffraction peaks were observed after 200 °C, and at high temperatures (1000 °C), the diffraction peaks of all samples remained clear, indicating that the Au maintains good thermal stability at elevated temperatures. Adding the reducing agents to the Au-MOD precursor solution led to the formation of Au nanoparticles. Their UV-Vis absorption spectra showed peak absorbance at different wavelengths ranging from 480 to 600 nm (FIG. 9), indicating variations in particle size and distribution of the Au nanoparticles. The sheet resistance of Au ink sintered at 180 °C revealed that films reduced with NaBH₄ exhibited the lowest sheet resistance (33 mΩ/sq. in FIG. 2a), whereas films reduced with dopamine had the highest sheet resistance (49 mΩ/sq.). This difference can be attributed to the reducing agents' influence on nanoparticle size, distribution, and carbonized residues (FIG. 10). The NaBH₄ produced smaller and more uniform Au nanoparticles (FIG. 10), resulting in better particle connectivity and lower resistance (FIG. 2a). In contrast, dopamine produced larger particles with carbonized residues, reducing particle contact and thus increasing the resistance (FIG. 2a & FIG. 10). Therefore, the printable Au-MOD ink with NaBH₄ is selected for the subsequent experiments. The effect of different Au-MOD ink concentrations on sheet resistance was further investigated (FIG. 2b). As the concentration of Au-MOD ink increased, the sheet resistance of printed Au film significantly decreased. At lower concentrations, the SEM images revealed that Au particles were dispersed with poor connectivity, resulting in higher resistance values (FIG. 2b & FIG. 11). However, when the concentration reached 2.0 mg/μl or higher, the Au particles formed a dense, continuous network, reducing the sheet resistance to 3.25 Ω/sq. (FIG. 2b & FIG. 11). At 20.0 mg/μl, the sheet resistance of printed Au film reached its lowest value (0.042Ω/sq.), as the film became highly dense and continuous, with minimal porosity (FIG. 2b & FIG. 11).

Upon increasing the annealing temperature to 1000 °C, Au nanoparticles are fused while a highly continuous and uniform monolayer Au film was formed (FIG. 2c & FIG. 12). The uniform texture indicated a well-distributed arrangement of Au nanoparticles during the sintering process, resulting in a film surface with fewer defects (FIG. 2d). The cross-sectional SEM images of the printed Au film showed a thickness of approximately 4.5 μm. The embedded Au element distribution demonstrated that Au was uniformly distributed as a monolayer throughout the entire thickness of the film. This uniform cross-sectional distribution played a key role in ensuring optimal electrical conductivity of the film. The XRD patterns of Au films sintered at 180 and 1000 °C exhibited the characteristic peaks of face-centered cubic (FCC) Au (FIG. 2e), with reflections corresponding to the (111), (200), (220), (311), (222), and (400) facets (JCPDS file: 04-0784). The sharper and more pronounced peaks sintered at 1000 °C indicate improved crystallinity, which correlates with enhanced electrical conductivity. Even with small amounts of impurities, the continuity and conductivity of the Au film can be maintained after high-temperature treatment at 1000 °C. This is because the impurities tend to aggregate and separate from the Au phase (FIG. 13). The relationship between the sheet resistance (R) and conductivity (o) of the Au films and sintering temperature (FIG. 2f) shows that as the temperature increases, the sheet resistance slightly decreases, reaching 20.5 mΩ/sq. at higher sintering temperatures. Correspondingly, the conductivity of printed Au increases to 10.8 MS/m, suggesting that higher temperatures facilitate improved particle sintering and reduce grain boundary resistance.

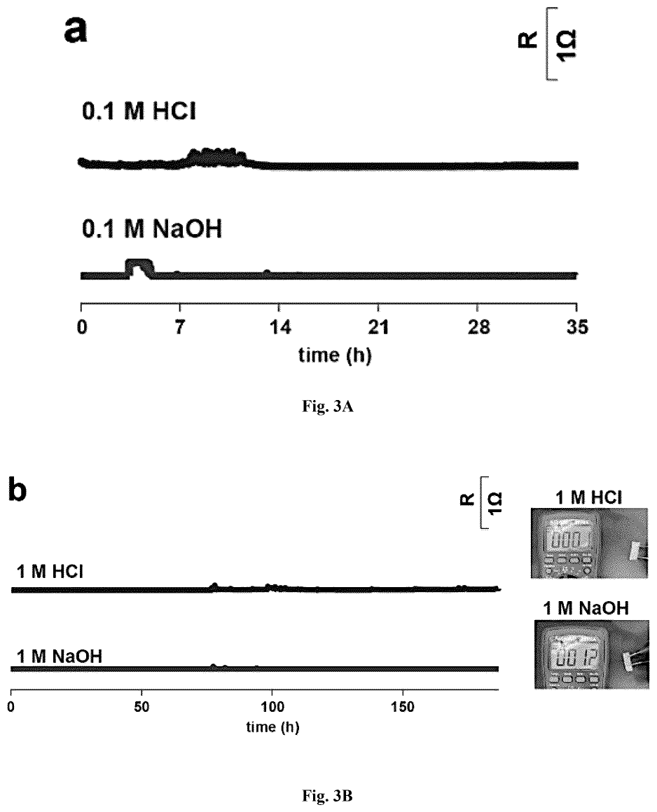

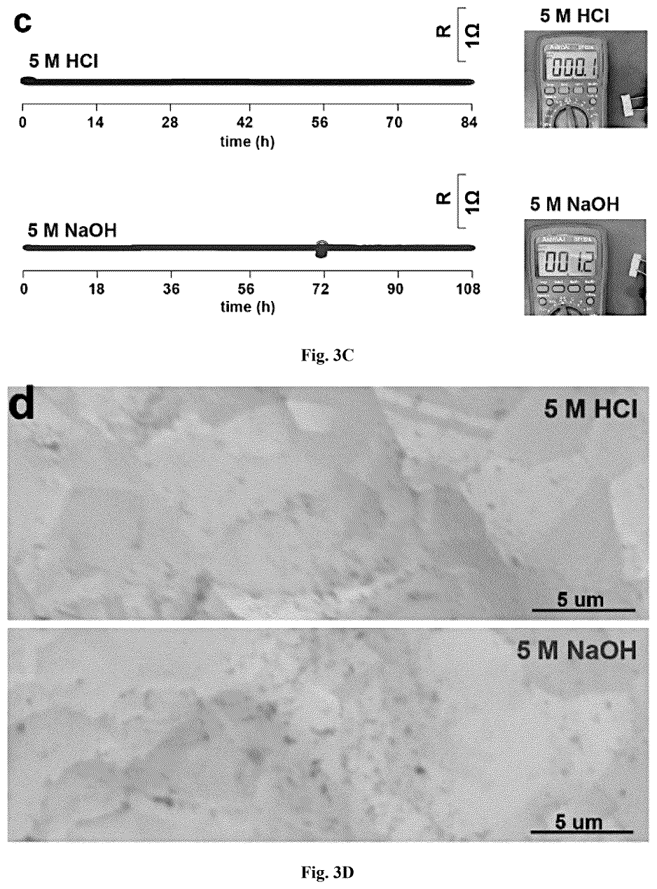

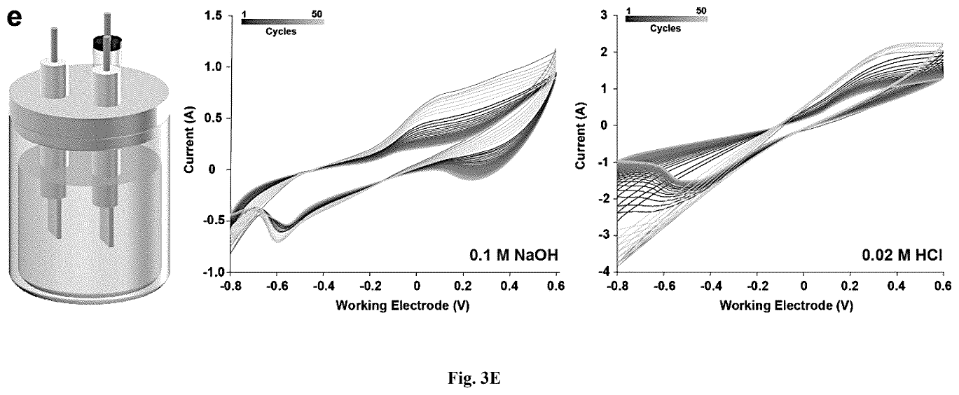

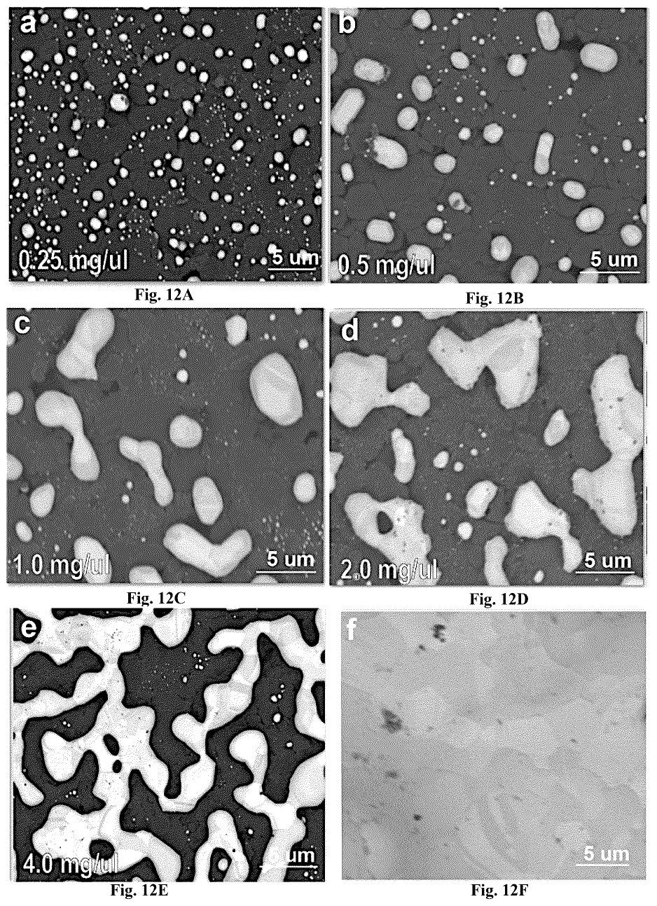

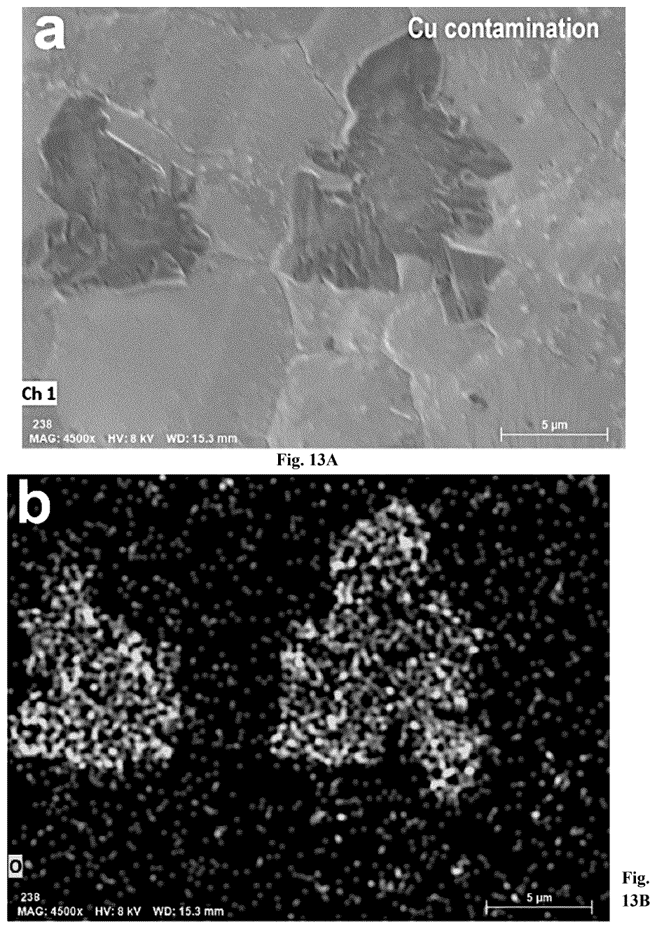

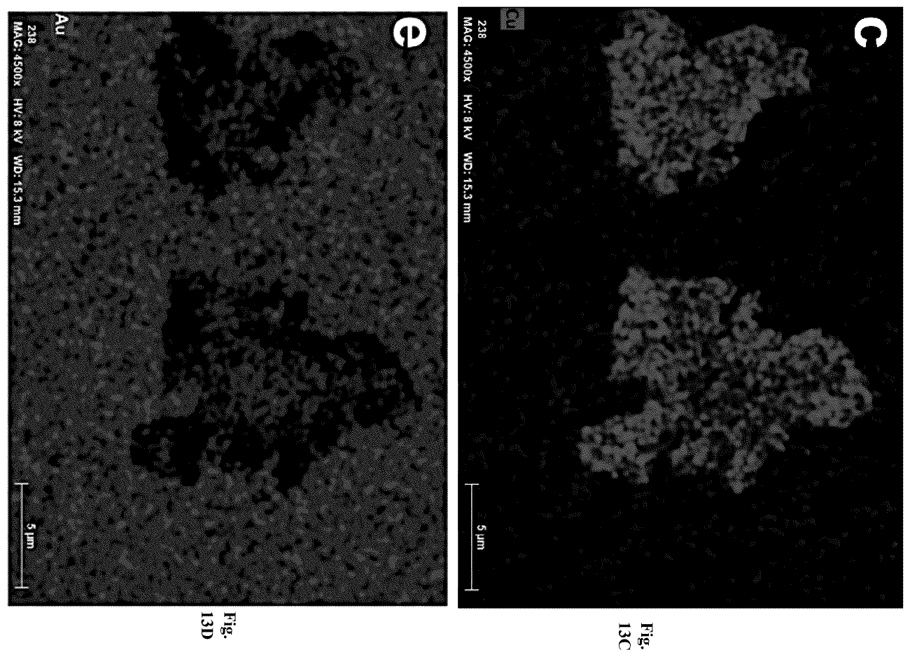

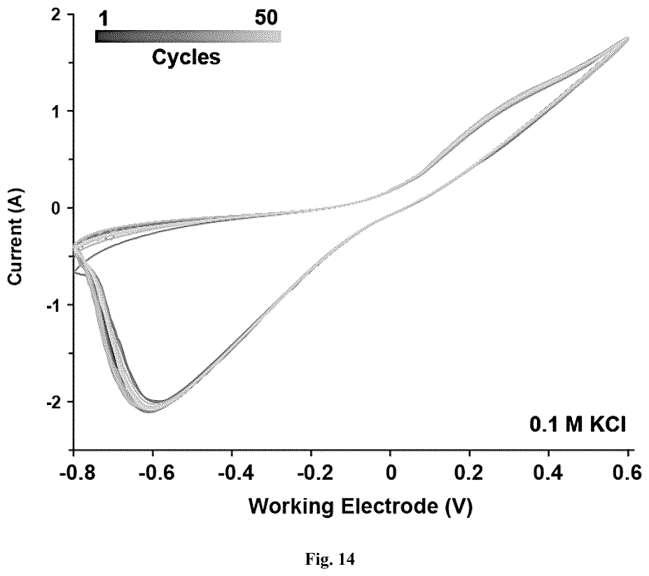

Printed conductor materials must meet design parameters for cyclic fatigue and creep-fatigue, especially in corrosive environments. Ensuring stability and longevity is crucial for maintaining performance under these harsh conditions. Throughout their operational lifespan, engineering materials are susceptible to damage caused by electrical breakdown and electrochemical corrosion. To evaluate the corrosion resistance, accelerated corrosion tests were conducted for the printed Au conductors. The resistance of printed Au conductor remained stable at 40 mΩ in 0.1 M, 1 M, and 5 M HCl and NaOH solutions (FIG. 3a-c). In 0.1 M HCl and NaOH, its resistance stayed stable for over 35 hours. In 1 M solutions, its stability exceeded 190 hours, and in 5 M solutions, it lasted over 84 hours (FIG. 3a-c). This confirms the excellent chemical stability of the Au films in strong acids and bases (FIG. 3b, c). The SEM images after 5 M HCl and NaOH immersion showed smooth surfaces (FIG. 3d), with little to no degradation. These findings further verify the high stability of Au films under harsh conditions. The cyclic voltammetry curves show the electrochemical response of Au films in 0.02 M HCl, 0.1 M NaOH, and 0.1 M KCl. FIG. 3e includes a schematic of the electrochemical cell used for the cyclic voltammetry measurements. In 0.1 M NaOH, the cyclic voltammetry curves showed oxidation and reduction peaks at approximately 0.1 V and −0.55 V, respectively, with stable current peaks between-0.8 V and 0.6 V (FIG. 3e). The current density increases with more cycles, but the peak shapes remain consistent. This shows good redox reversibility and high electrochemical stability in alkaline conditions. In 0.02 M HCl, the oxidation and reduction peaks were broader and located at around 0.4 V and −0.5 V, respectively (FIG. 3e), suggesting slower kinetics and possible surface degradation in acidic conditions. In 0.1 M KCl, the cyclic voltammetry curves show reversible redox behavior, with oxidation and reduction peaks occurring at approximately 0.3 V and −0.6 V, respectively (FIG. 14). This indicates effective charge transfer during the electrochemical process. These results highlight the differences in Au films' electrochemical behavior in acidic and basic environments. Au films perform well in alkaline environments but may degrade in strong acids.

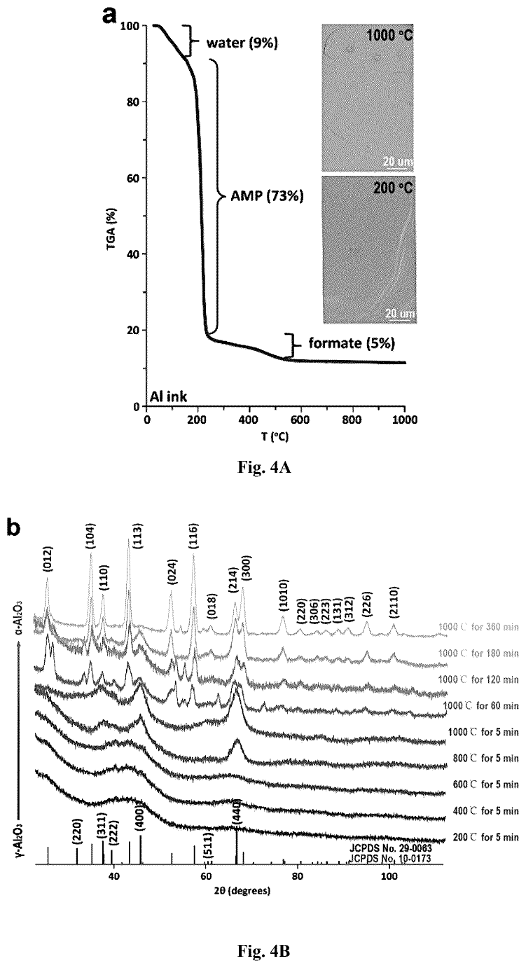

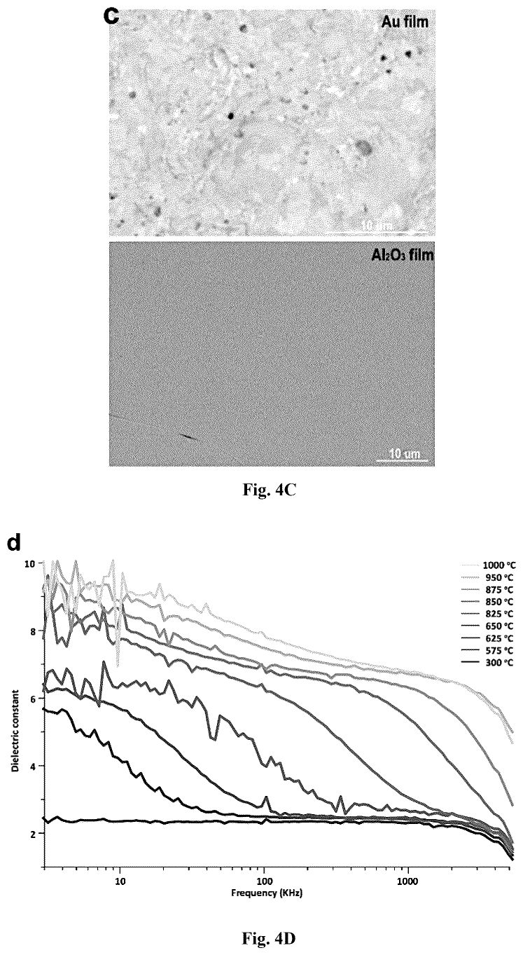

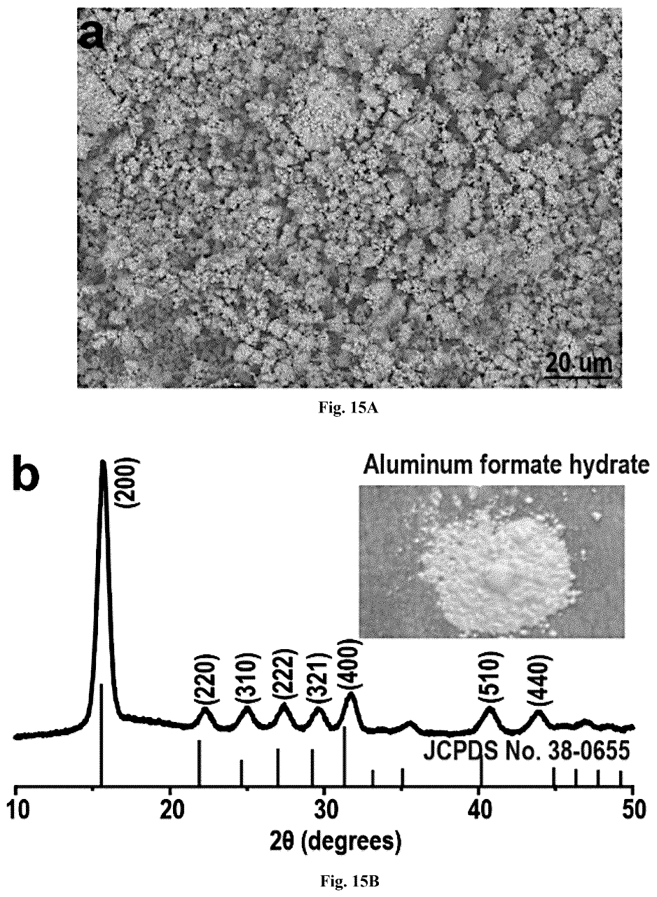

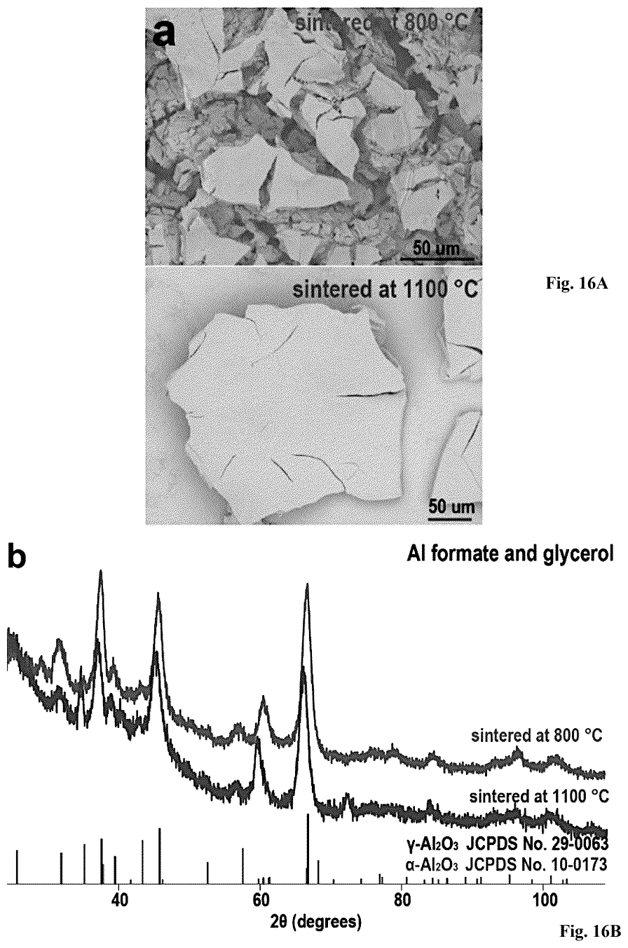

The Al-MOD ink consisting of Al-formate was obtained through hydrothermal synthesis, with reflections corresponding to the (200), (220), (310), (222), (321), (400), (510), and (440) planes (JCPDS file: 38-0655) (FIG. 15). The transparent colloidal solution, formed by mixing Al formate with AMP (2-amino-2-methyl-1-propanol), served as the printable Al-MOD ink. It was further attempted to prepare Al-MOD ink using glycerol and Al formate. However, due to their poor compatibility, the calcined Al₂O₃ failed to form a continuous and uniform film (FIG. 16). Thermogravimetric analysis (TGA) of the Al-MOD ink (FIG. 4a) shows that weight loss occurs in three distinct stages. The first stage, with about 9% weight loss below 150 °C, corresponds to water evaporation. The second stage involves the evaporation of organic solvent AMP, accounting for 73% of the weight loss, and occurs between 15° and 200 °C The final 5% weight loss is attributed to the formate decomposition. These results are consistent with the decomposition pathway typical of organometallic inks. The XRD patterns of Al₂O₃ films sintered at different temperatures and durations reveal the evolution of crystal phases (FIG. 4b). At 200 °C, the films are mostly amorphous, with weak diffraction peaks. As the sintering temperature increases to 400 °C and above, γ-Al₂O₃(JCPDS file: 38-0655) and α-Al₂O₃ phases (JCPDS file: 38-0655) start to form more distinctly. When the sintering temperature reaches 1000 °C, the peaks become sharper, indicating increased crystallinity. Notably, after sintering at 1000 °C for 360 minutes, the crystallinity significantly improves, suggesting the formation of the thermally stable α-Al₂O₃ phase. The FTIR spectra reveal the chemical structure changes during the calcination process of Al formate (FIG. 17). First, the reference sample Al(OH)₃ shows a distinct hydroxyl (OH) stretching vibration band at around 3400 cm⁻¹. In the uncooked Al formate, the asymmetric and symmetric stretching vibrations of carboxyl groups (COO⁻) appear between 1700-1400 cm⁻¹. Due to the incorporation of AMP in the Al-MOD ink, the hydroxyl and carboxyl peaks from formate and AMP remain present at 200 °C. As the temperature rises to 600 and 1000 °C, the hydroxyl and carboxyl peaks disappear, indicating that most organic compounds have decomposed. This result aligns with the TGA findings. Under these temperature conditions, the Al₂O₃ undergoes phase transitions, forming a uniform film structure.

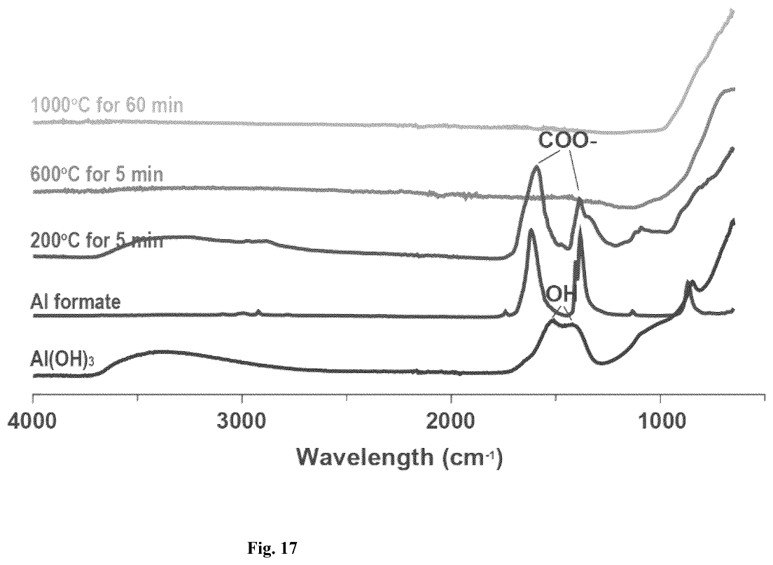

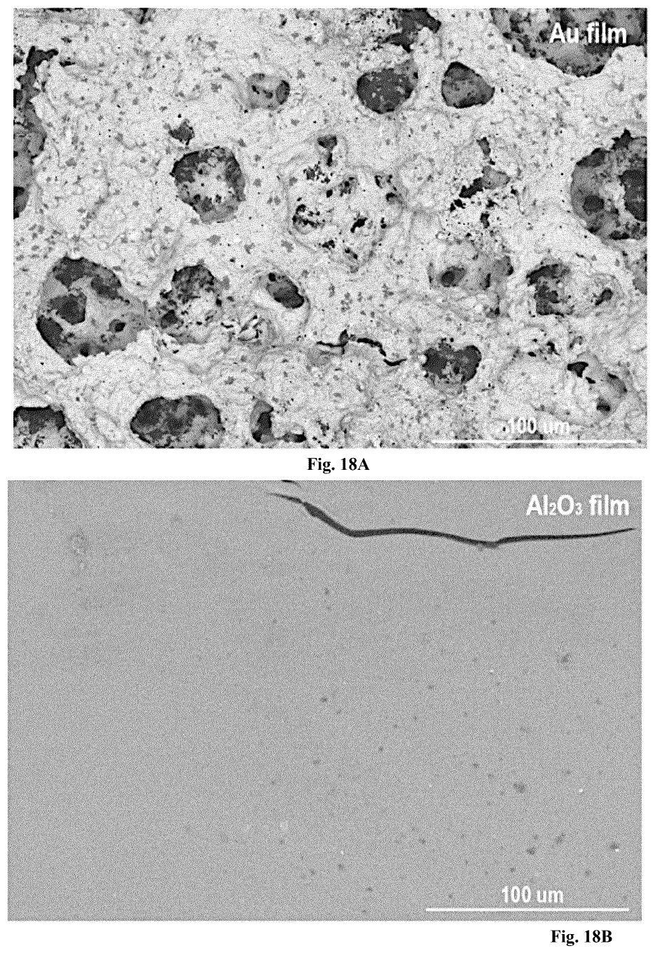

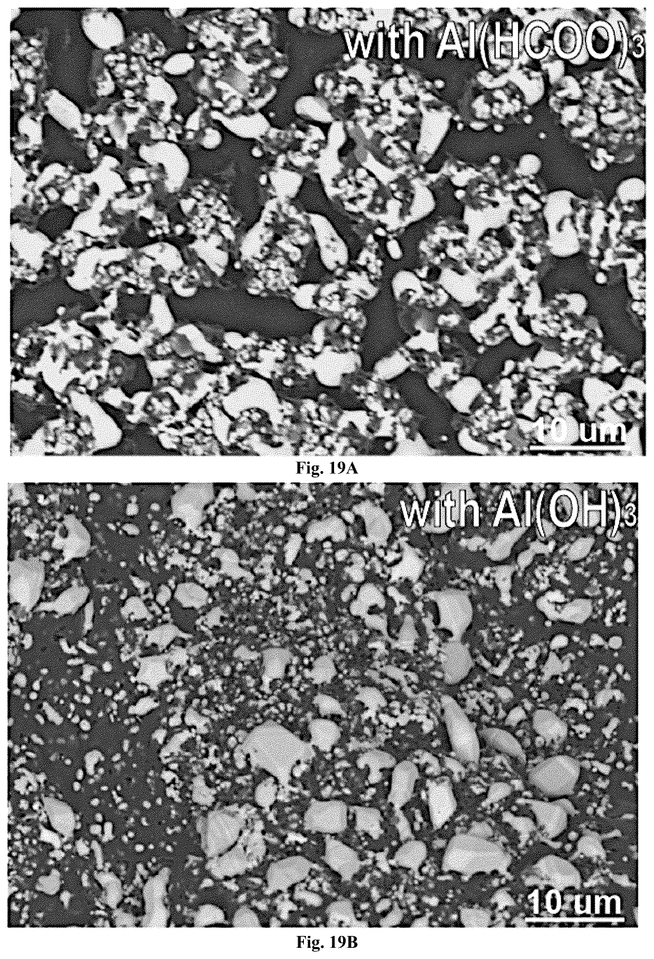

The SEM images revealed the surface morphology of the sintered Au and Al₂O₃ films (FIG. 4c and FIG. 18). The mixture of Au-MOD and Al-MOD ink underwent phase separation after high-temperature calcination (FIG. 19). This phenomenon supports the conclusion that the printed Au and Al₂O₃ would remain separate and not fuse during thermal processing. Both films present smooth and uniform surfaces with minimal defects. A capacitor was constructed to test the dielectric constant of Al₂O₃, using printed Au as the top and bottom electrodes and an alumina film as the dielectric layer. The dielectric constant was calculated using the following equation::

$${ϵ}_{r} = \frac{C \times d}{{ϵ}_{0} \times A} ∘$$

where C represents the capacitance, A, and d denote the capacitor's area (1.6×10⁻⁵ m²) and thickness (5×10⁻⁴ m), respectively. ϵ₀ is the vacuum permittivity, 8.854×10⁻¹² F/m. The results indicated that dielectric performance varies with the sintering temperature (FIG. 4d). Films sintered at lower temperatures (300 °C) exhibited a dielectric constant of approximately 2.3 at 10 kHz, while films sintered at higher temperatures from 600 to 1000 °C showed dielectric constants increasing from 5 to 9.5. This behavior suggests that improved crystallinity and enhanced phase transitions at elevated temperatures contribute to the enhancement of dielectric properties. The increase in dielectric constant with temperature correlates with the formation of the α-Al₂O₃ phase, known for its high dielectric strength and thermal stability.

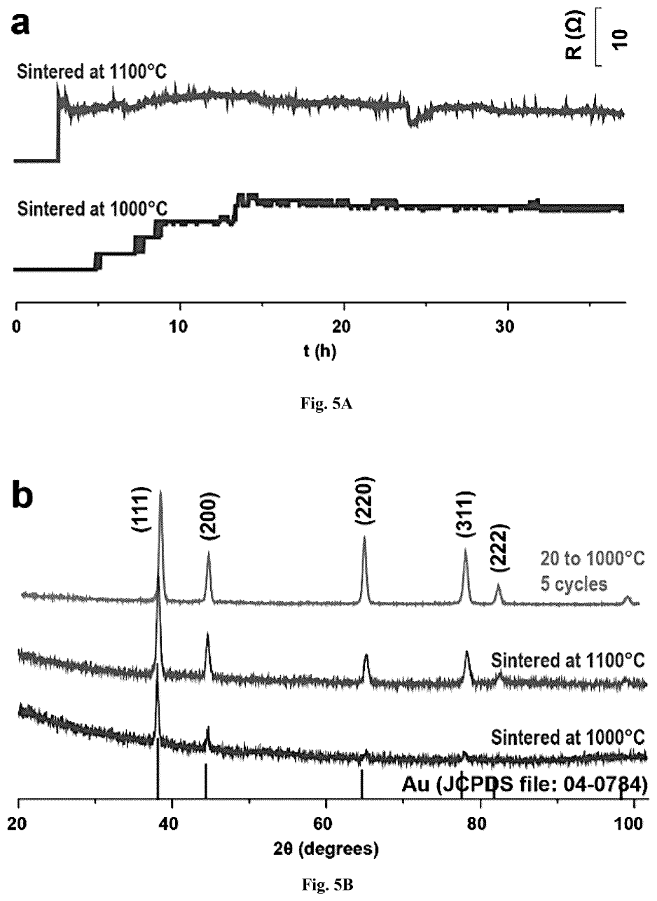

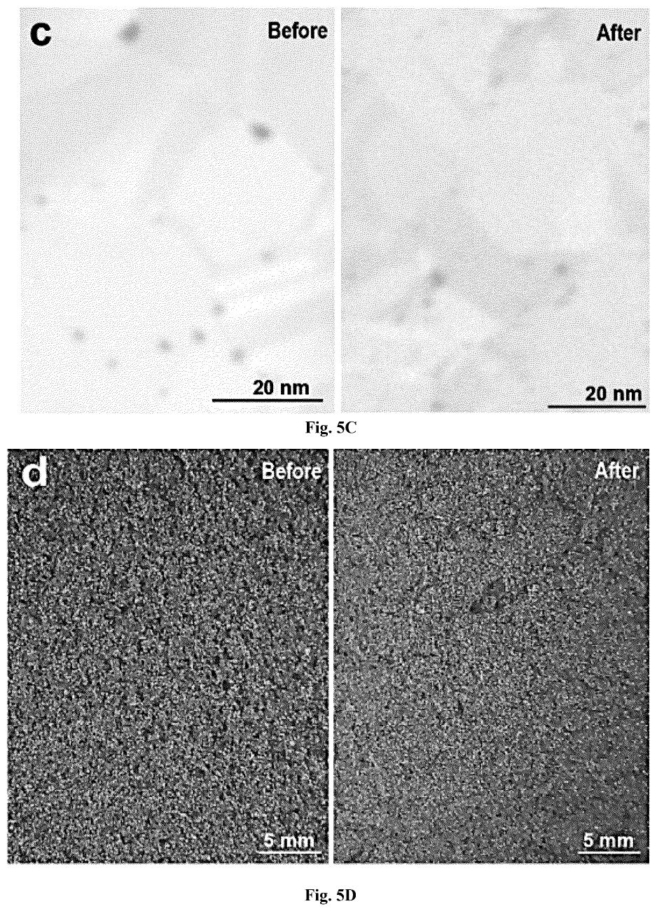

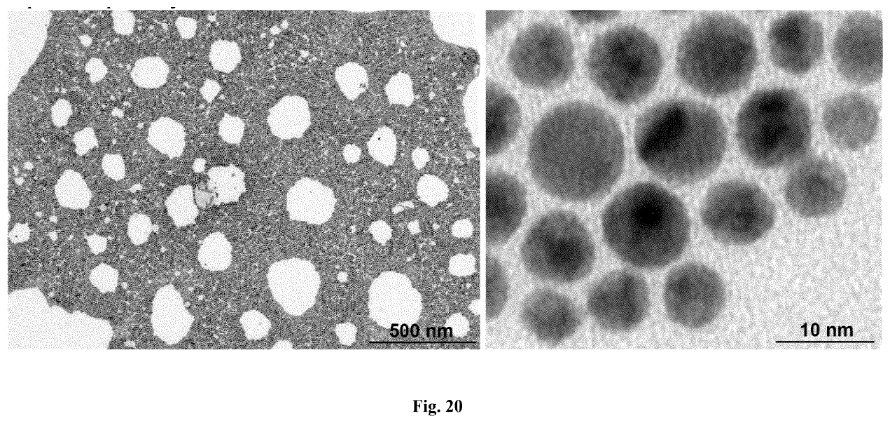

Materials must have thermodynamic resistance to reliably perform under high temperatures, ensuring robust performance in various technical applications and conditions, especially in extreme environments. These materials must resist not only melting but also failure from thermal stress and degradation from phase changes, oxidation, vaporization, or ablation to perform in extreme conditions. Therefore, the work focused on the oxidation resistance of printed Au films sintered at various temperatures. The resistance (R) of Au films sintered at 1000 and 1100 °C was monitored (FIG. 5a). Au film exhibited good stability over 37 hours, although fluctuations in resistance were observed due to the oxidation sensitivity of the transmission lines. The XRD patterns (FIG. 5b) revealed structural changes in the Au films sintered at 1000 °C and 1100 °C. Both patterns show clear diffraction peaks corresponding to the crystalline Au phase (JCPDS file: 04-0784). SEM images (FIG. 5c) and optical images (FIG. 5d) show the consistent nanoscale morphology of Au films before and after the resistance temperature test at 1000 °C This result indicates that the Au film exhibits excellent high-temperature resistance, reaching up to 1100 °C. In-situ wide-angle X-ray scattering (WAXS) spectra were used to detect Au nanoparticle ink with an average size of 8 nm (FIG. 20). The results showed that clear Au scattering signals could be observed at temperatures above 100 °C, although the signal intensity decreased after 700 °C due to sample height changes caused by thermal expansion (FIG. 5e). Here, no spotty scattering was observed in this system, indicating that the Au nanoparticles remained uniformly distributed even at 1000 °C (FIG. 5f).

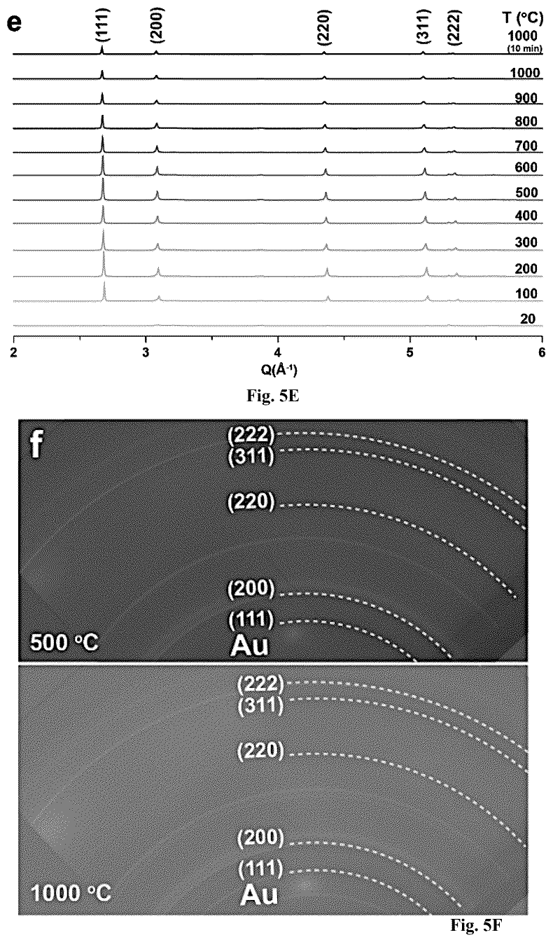

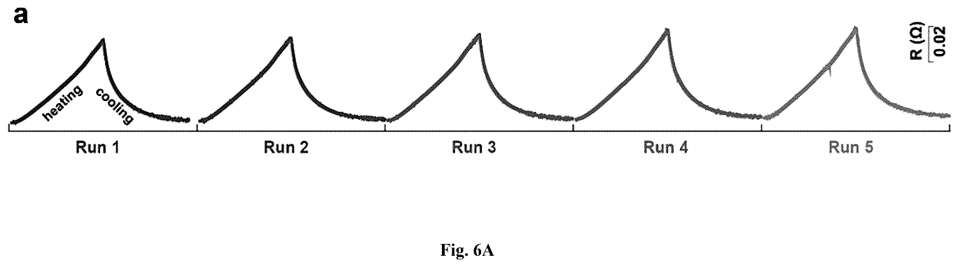

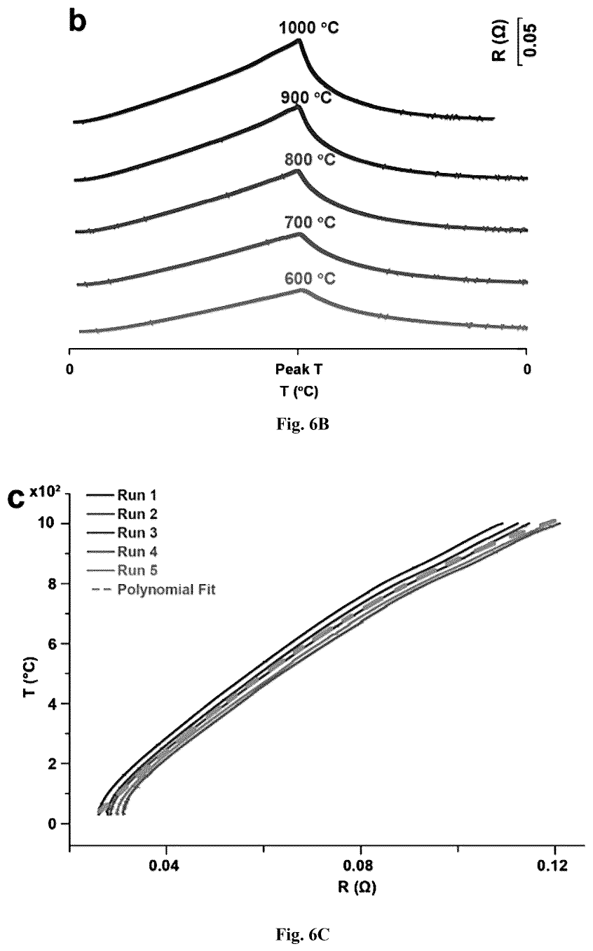

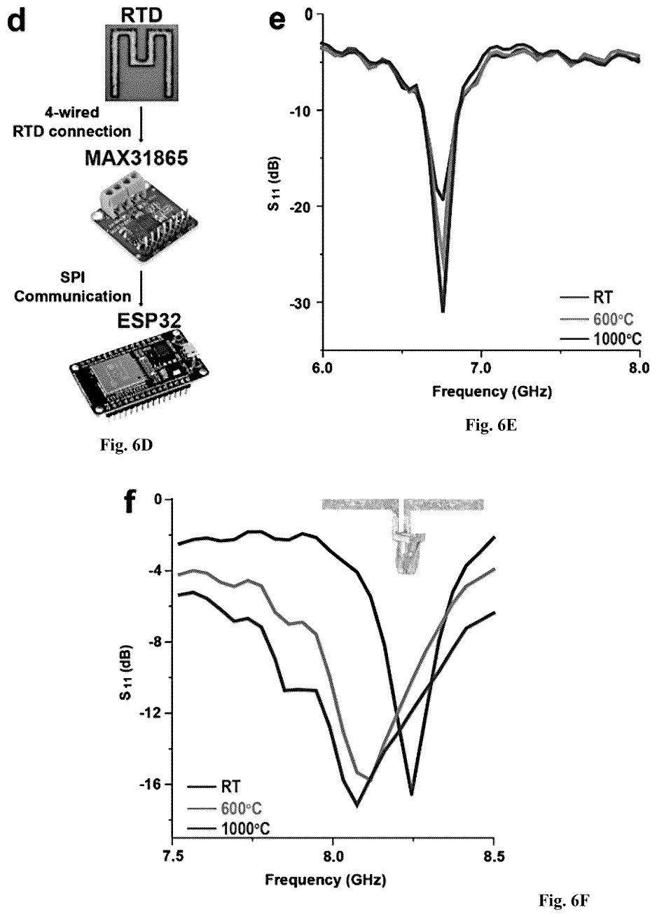

High-temperature electronics require functional materials that can maintain their electrical conductivity while also displaying high oxidation resistance. Therefore, it is important to enhance a metal's oxidation resistance without compromising conductivity to meet the requirements of harsh environments. Achieving high-temperature sensitivity in printed high-temperature resistance-temperature detectors (RTDs) necessitates careful consideration of factors like the material, configuration, resistance temperature coefficients (TCR), oxidation resistance, and manufacturing requirements. A thermal cycling test is important for evaluating electronics reliability, involving rapid temperature fluctuations applied to materials or electronics. This environmental stress test helps assess the longevity and safety of products, quickly identifying potential flaws and improving design and dependability. The thermal cycling characteristics of printed Au during heating and cooling between RT and 1000 °C were evaluated (FIG. 6a). As the temperature increased, the sample displayed an increased resistance, which can be attributed to the metallic character of Au. Moreover, once the cooled to RT, the Au film recovered to its initial resistance value. The repeatability of these cycles shows that the resistance fluctuates by only 0.05Ω below 1000 °C and is recoverable, indicating that the one-step printed Au conductors have good thermal stability across different cycles. Additionally, the thermal stability of Au was confirmed by the consistent crystalline structure during thermal cycling.

The performance of the printed Au RTD was further evaluated at temperatures ranging from 600 to 1000 °C (FIG. 6b). The curve exhibits a positive temperature coefficient and a reversible trend in all the runs, indicating that the Au-based RTD sustains thermal cycling, likely due to enhanced grain boundary and surface scattering effects. The positive trend is consistent with metallic conductors and can be used to calculate the temperature coefficient of resistance (TCR, a). This coefficient is defined as the relative change in resistance per degree measured and is given by the formula R₂=R₁×[1+α(T₂−T₁)], where T₁ and T₂ represent the initial and final temperatures, and R₁ and R₂ represent the initial and final losses. The sensitivity(S) is the product of initial resistance and TCR. The a value determined for the 600 °C run is 2.53×10⁻³/°C, while the S value is 7.31×10⁻⁵ (2/°C. Similarly, at a temperature of 700 °C, a is 2.54×10⁻³/°C, while Sis 7.67×10⁻³Ω/°C. For 800 °C, a is 2.67×10⁻³/°C, while Sis 8.11×10⁻⁵Ω/°C. At 900 °C, a is 2.88×10⁻³/°C, coupled with S as 8.52×10⁻⁵Ω/°C. At a temperature of 1000 °C, the value of a is 2.83×10⁻³ PC, while Sis 8.23×10⁻⁵Ω/°C. Due to the Au conductor's effectiveness as a temperature sensor at extreme temperatures, an Arduino board was developed to evaluate its wireless RTD potential. Five thermal cycles up to 1000 °C were conducted using a curve-fitting method to determine the exponents for real-time data updates via the Arduino (FIG. 6c). A second-order polynomial fit was employed to derive a temperature equation as T=C+B₁R+B₂R², where Tis temperature, R is resistance, B₁ and B₂ are the coefficients, and C is the intercept. The coefficients are: C=−397.64, B₁=18097.28, and B₂=−53052.96. For data transfer about the resistance and its accompanying temperature, a data acquisition and wireless communication system was employed (FIG. 6d). The MAX31865 amplifier board, with a four-wire connection, measures and corrects lead resistance before each reading, using a 15-bit ADC to achieve 0.5 °C precision when paired with a standard PT10 RTD. The measured resistance is sent via SPI to an ESP32 microcontroller, which converts it to temperature using a calibration function in the Arduino code. With 802.11 b/g/n Wi-Fi capability, the ESP32 is well-suited for wireless communication. The system also incorporates a simple recursive exponential filter in the Arduino module to reduce noise efficiently, without the complexity of a moving average filter.

A top-down bilayer structure, consisting of printed Al₂O₃ dielectric substrate and Au conductor, is additively manufactured to build antenna sensor electronics. The Su parameter illustrated the frequency response of Au films at RT and 600 to 1000 °C (FIG. 6e). The Su parameter shows changes in the reflection coefficient due to minor conductivity variations as the temperature increases. At RT, the reflection coefficient is −31.09 dB at 6.75 GHZ, shifting to-25.51 dB at 600 °C and −19.30 dB at 1000 °C. The recorded S11 curves of the Al₂O₃-coated Au dipole antenna sensor at RT, 600 °C, and 1000 °C exhibit distinct resonances (FIG. 6f). The resonance frequency at RT is 8.24 GHz. In this context, the resonance frequency is precisely defined as the frequency that corresponds to the lowest amplitude observed in the S₁₁ curve. At a temperature of 600 °C, the frequency shifts towards 8.11 GHz and a reflection coefficient value of −15.76 dB, and for 1000 °C, the frequency shifts towards 8.11 GHz, with a reflection coefficient value of −10.22 dB. The frequency shift arises from the shift in the dielectric constant of alumina coating on the Au dipole antenna. A higher reflection coefficient indicates sharper resonance behavior, which can improve sensor resolution. However, in temperature sensing, the resonance frequency is often used to indicate temperature, and even lower resonance amplitudes can be effective. In conclusion, Au films sintered at higher temperatures exhibit good stability, low resistance, and consistent frequency performance, highlighting their potential for high-temperature electronic applications.

A one-step additive manufacturing coupled with thermal conversion of oxidation- and corrosion-resistant metal and ceramic materials created by thermal decomposition of molecular decomposable inks was introduced.

All publications mentioned herein are incorporated by reference to the extent they support the present invention.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.

We claim:

1. A noble metal-based ink composition, said composition comprising a metal salt and a reducing agent, and optionally an organic solvent or water.

2. The noble metal-based ink composition of claim 1, wherein said ink composition is a metallic MOD ink composition.

3. The noble metal-based ink composition of claim 1, wherein said metal has a reduction potential of at least 1.2.

4. The noble metal-based ink composition of claim 1, wherein said metal is gold, silver, palladium, or platinum.

5. The noble metal-based ink composition of claim 1, wherein said salt is a halide, carboxylate, nitrates, or sulfates.

6. The noble metal-based ink composition of claim 1, wherein said metal salt is present in a concentration of about 1 mmol to about 10 mmol.

7. The noble metal-based ink composition of claim 1, wherein said reducing agent is sodium borohydride.

8. The noble metal-based ink composition of claim 8, wherein said sodium borohydride is present in a concentration of about 0.01 mmol to about 0.2 mmol, preferably about 0.05 mmol.

9. A noble metal-based ink composition, said composition comprising a metal salt, a reducing agent, an organic acid, and an organic solvent or water.

10. The noble metal-based ink composition of claim 9, wherein said reducing agent is dopamine.

11. The noble metal-based ink composition of claim 9, wherein said ink composition is a MOD ink composition.

12. The noble metal-based ink composition of claim 9, wherein said metal has a reduction potential of less than 1.2.

13. The noble metal-based ink composition of claim 9, wherein said metal is gold, silver, palladium, or platinum.

14. The noble metal-based ink composition of claim 9, wherein said salt is a halide, carboxylate, nitrates, or sulfates.

15. The noble metal-based ink composition of claim 10, wherein said dopamine is present in a concentration of about 0.005 mmol to about 0.1 mmol.

16. A high redox metal-based ink composition, said composition comprising a metal salt and optionally, formic acid.

17. The high redox metal-based ink composition of claim 16, wherein said ink composition further comprises an amino solvent.

18. The high redox metal-based ink composition of claim 16, wherein said ink composition is a MOD ink composition.

19. The high redox metal-based ink composition of claim 16, wherein said metal is a Group IV-VI metal.

20. The high redox metal-based ink composition of claim 16, wherein said metal has a reduction potential of more than 1.2.
